(19) United States
(12) Patent Application Publication
(10) Pub. No.: US 2012/0110868 A1
(43) Pub. Date: May 10, 2012

(54) PROTECTIVE COVER AND SYSTEM FOR ELECTRONIC DEVICES TECHNICAL FIELD

(76) Inventor: Matthew Lucianno Abbondanzio, (US)

(21) Appl. No.: 13/192,432

(22) Filed: Jul. 27, 2011

Related U.S. Application Data
(60) Provisional application No. 61/367,939, filed on Jul. 27, 2010.

(51) Int. Cl. G01B 1/00; B32B 33/00

(52) U.S. Cl. 33/645; 428/41.7

(57) ABSTRACT

A system for applying a protective layer on the screen of an electronic device is disclosed. The system includes an alignment tray with one or more alignment lugs molded into the tray. The electronic device is then placed into the tray with the screen up. A combination protective layer/release layer is then placed over the tray and electronic device and holes in the combination protective layer/release layer are then placed over the lugs for proper alignment. The release layer is then removed then either two pieces utilizing a slit that extends through the release layer only or using a pull tab that may be easily separated from the protective layer using a slit or die cut line in the protective layer at the base of the pull tab.

This application claims benefit of our provisional application, No. 61367939 filed on Jul. 27, 2010.

### BACKGROUND OF INVENTION

Mobile Electronic Devices

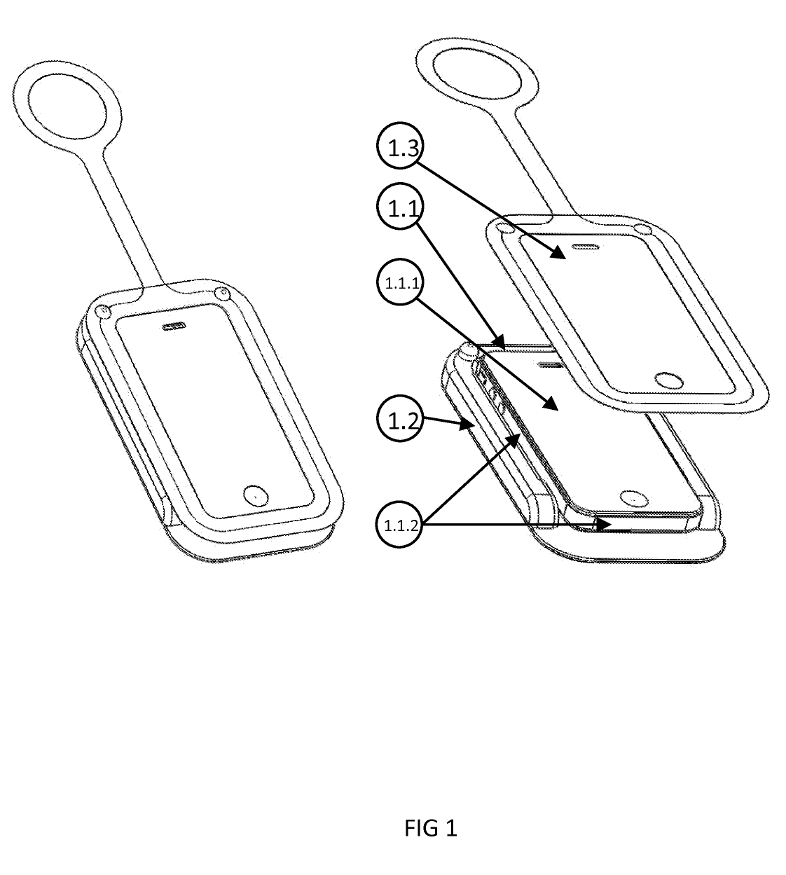

Currently the format for mobile electronic devices (FIG. 1.1), such as the iPhone™, iPad™, Motorola Xoom™ etc. is moving towards a simple touch screen system that comprises of just a glass (FIG. 1.1.1) and minimal functional buttons. This format provides very little to no physical features from which to align accessories to them.

Protective Screens

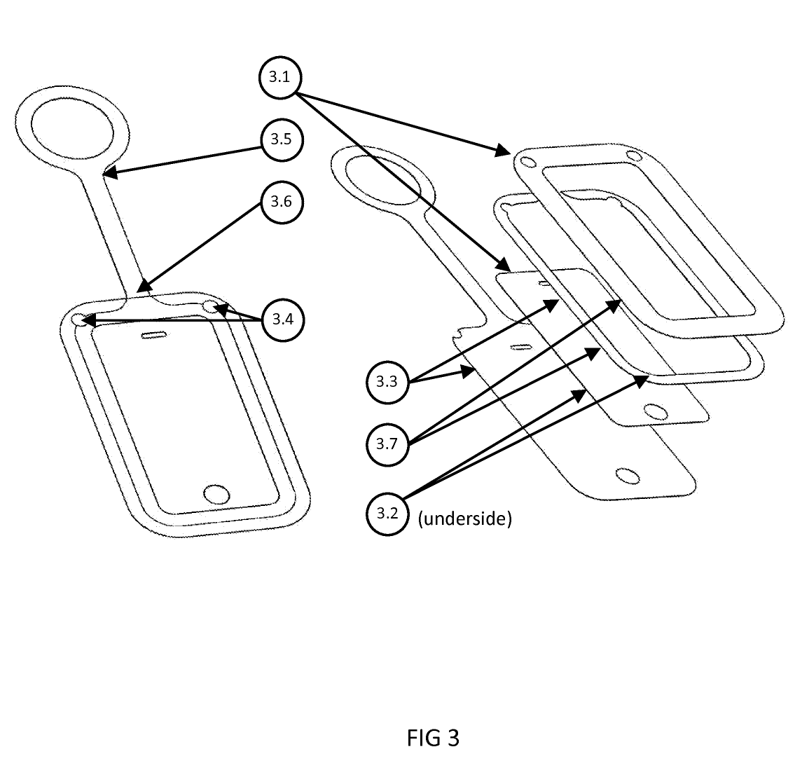

With the advent of these devices, their interactive glass screens and the high cost of these devices an industry of Polyester (PET) based protective screens (FIG. 3-3.1) with a self wetting silicone based adhesive (FIG. 3.2) has sprouted up to help consumers protect their investments by covering the glass fronts of their devices with a thin sheet of hard PET. This protective layer helps reduce the risk of scratches and blemishes to the screen of the device.

Release Layer

The release layer (FIG. 3.3) is a thin layer of Polyester or other material, usually thinner than the protective PET layer. This release layer is applied to the exposed adhesive at the manufacturer to protect the adhesive prior to the protective screen's application. This layer is a sacrificial layer removed by the user just prior to the application of the protective screen exposing the adhesive to the electrical device's glass surface.

Alignment

The use of these protective screens requires the application of the protective screen to be completed without the air bubbles and other contaminants such as dirt and dust so that the optical clarity of the underlying device screen remains intact. The main cause of these air bubbles is due to poor application by the user. The majority of reason why there is poor application by the user is the lack of ability for the user to properly align these protective screens to their electronic devices. Additionally, exposure of the adhesive on the protective screens to the open air allows for dirt and dust particles to collect on the adhesive and cause air bubbles once application occurs. Proper alignment of the protective screen to the electronic device is critical and without physical features on the electronic device is almost impossible.

### SUMMARY OF THE INVENTION

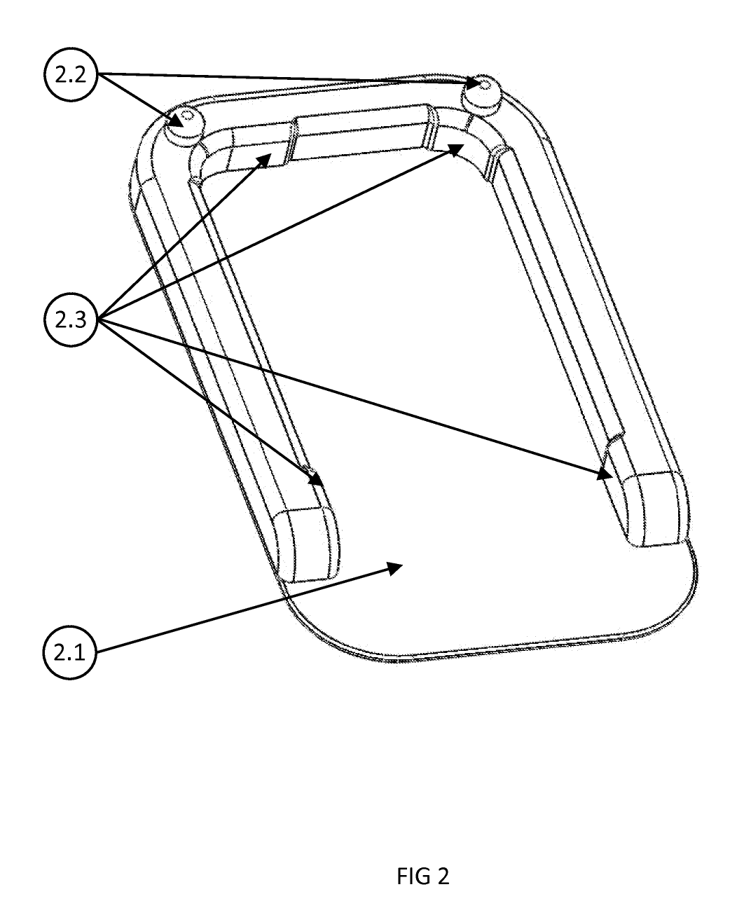

The invention is for any system that utilizes a separate alignment tray to help align the electronic device to a protective screen. The electrical device is placed into the alignment tray (FIG. 2.1). The electrical device is registered to the alignment tray using single or multiple edges (FIG. 1.1.2 of the electrical device and the single or multiple edges of the alignment tray (2.3). The tray will also register to the protective screen by means of either the edge of the protective screen (FIG. 2.3), a preassembly of the protective screen to the tray from the manufacturer or by the means of another geometric feature. One embodiment of another geometric feature could be the use of positive alignment features (FIG. 2.2) on the tray and negative alignment features (FIG. 3.4) in the protective layer. In this embodiment, the negative alignment features (holes) in the protective screen would be placed onto the positive alignment features (lugs) on the alignment tray. With the electronic device seated in the tray, the protective screen would then be aligned to the electrical device and able to be applied properly.

One embodiment of the protective screen includes the ability to pull the release layer off of the protective screen while the adhesive is facing downward minimizing the ability for dust to collect on the exposed adhesive prior to application. The combination protective layer/release layer is equipped with a pull tab (FIG. 3.5). A slit (FIG. 3.6) is placed through the protective layer at the base of the pull tab. The device is placed in the alignment tray as described above. The combination protective layer/release layer/pull tab is placed over the electronic device and holes in the protective layer/release layer are placed over the alignment lugs. The protective layer is then removed from the pull tab portion and then the pull tab is removed thereby removing the bulk of the release layer in one piece. A margin or a small portion of the release layer may remain on the edge of the alignment tray or the edge of the electronic device, which may be easily removed.

### BRIEF DESCRIPTION OF THE DRAWINGS

FIG. 1. Is a system level diagram that:
1.1. shows a mobile electrical device
   1.1.1. shows the interactive glass display that users are trying to protect
   1.1.2. shows the alignment edges of the electronic device
1.2. shows the alignment tray
1.3. shows the protective screen

FIG. 2. is a detailed view of the alignment tray:
2.1. is the alignment tray
2.2. shows the positive alignment features on the alignment tray
2.3. shows the alignment edges of the alignment tray

FIG. 3. is a detailed view of the protective screen
3.1. shows the layer of PET or protective plastic layer
3.2. shows the layer of self wetting adhesive
3.3. shows the layer of sacrificial release layer
3.4. shows the negative alignment feature on the protective screen
3.5. shows the pull tab
3.6. shows the slit through the release layer below the pull tab
3.7 shows the PET and release layers that extends beyond the usable protective screen

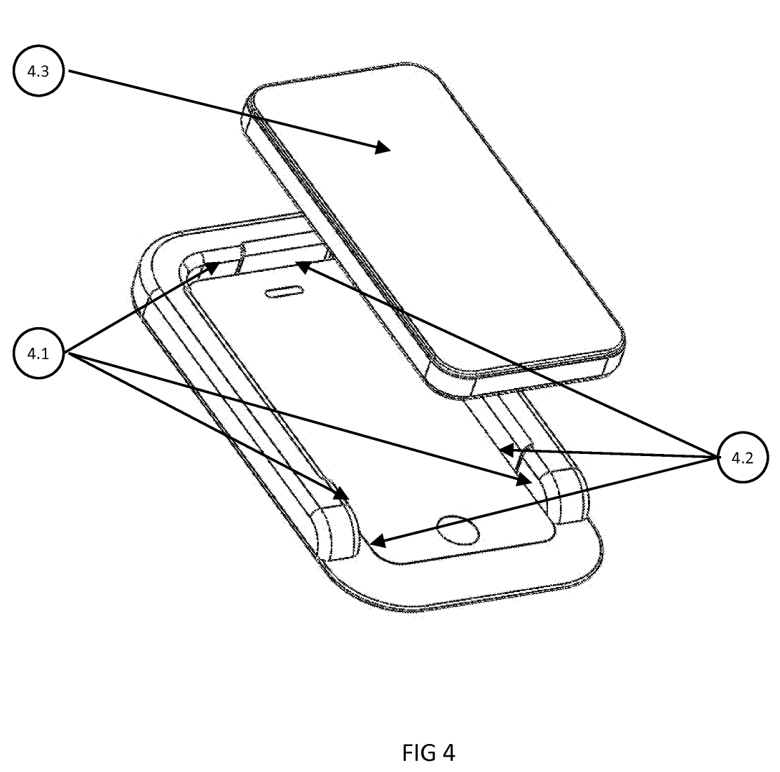

FIG. 4. Shows an alternate system using edges of the tray and edges of the protective screen to align the protective screen to the electrical device.
4.1 shows the alignment edges of the alignment tray
4.2 shows the alignment edges of the protective layer
4.3 shows the electronic device face side down

### DETAILED DESCRIPTION OF THE INVENTION

Turning to FIG. 1, an alignment tray or frame may be placed on a work surface and an electronic device placed within the tray. A combination protective layer/release layer with two holes disposed therein is then placed over the tray with the holes extending over location lugs disposed along a top edge of the tray. A slit has been disposed in the release layer thereby enabling a large portion of the release layer to be removed while the device is still in tray. Then the device and remaining release layer/protective layer are removed from the tray and the smaller piece of release layer may then be removed from the top of the device. As the release layer is removed from the electronic device, hand pressure may be applied to the protective layer to protect against bubbles or air pockets.

Turning to FIG. 3, a combination protective layer/release layer is shown. This embodiment features a pull tab. A die cut line is placed through the protective layer at the base of the pull tab. The combination protective layer/release layer is placed over the electronic device and alignment tray as illustrated in FIG. 1 with the holes in the combination protective layer/release layer being placed over the alignment lugs of the alignment tray. Then, the protective layer portion is removed from the pull tab and then the pull tab may then be removed thereby removing the bulk of the release layer in one piece. Portions of the release layer may remain around the outer margins of the alignment tray (FIG. 3.7) but may be removed quite easily.

Turning to FIG. 4, a separate system is shown utilizing the edges of the protective screen alone to align the protective screen to the device. The protective screen is placed within the alignment tray, one or more of its edges (FIG. 4.1-4.2) touching one or more of the inside edges of the alignment tray with the adhesive exposed and facing up. The electrical device is placed face down (FIG. 4.3) into the alignment tray with one or more edges of the electrical device touching the inside edges of the alignment tray. This placement initially adheres the protective screen to the electrical device's screen in proper alignment. The user can then take the electrical device and protective screen assembly out of the alignment tray and remove and remaining bubbles that may occur.

We claim:

1. A system to align a protective screen to an electrical device comprising:
an alignment tray with an alignment feature
a protective screen with an alignment feature that compliments the alignment feature incorporated in the alignment tray

2. The alignment tray in claim 1 that utilizes a singular or plurality of positive geometrical feature(s) to spatially register the electronic device to the alignment tray

3. The protective screen in claim 1 that utilizes a singular or plurality of negative geometrical feature(s) to spatially register the protective screen to the alignment tray

4. The alignment system in claim 1 that utilizes the preassembly of the protective screen/release layer to the alignment tray not by the end user.

5. The alignment system in claim 1 that utilizes the preassembly of the protective screen/release layer to the alignment tray by the end user.

6. A protective screen that comprise:
a layer of clear PET or the like
a layer of self wetting adhesive
a sacrificial release layer that applied to the exposed adhesive to protect it from containments

7. The protective screen in claim 6 that incorporates a pull tab attached to the release layer allowing the user to remove the entire release layer in one action

8. The protective screen in claim 6 that utilizes a split release layer allowing the user to remove the release layer in one large action and separately another smaller action.

9. The protective screen in claim 6 that has a cut through the PET or the like layer but not the release layer

10. The cut in claim 9 that allows the two separate PET or the like pieces remain in position during the removal of the release layer by the adhesion of both pieces of PET or the like to the main single piece of release layer.

11. A system to align a protective screen to an electrical device comprising:
an alignment tray with an alignment edges or surfaces
a protective screen with a alignment edges that compliments the alignment edges or surfaces incorporated in the alignment tray

12. The protective screen in claim 11 that utilizes a singular or plurality of edges that act as alignment features to spatially register the protective screen to the alignment tray

13. The alignment tray in claim 11 that utilizes a singular or plurality of edges that act as alignment features to spatially register the protective screen to the alignment tray

14. The alignment tray in claim 11 that utilizes a singular or plurality of edges that act as alignment features to spatially register the electrical device to the alignment tray
